(19) United States
(12) Patent Application Publication
(10) Pub. No.: US 2025/0136810 A1
(43) Pub. Date: May 1, 2025

(54) DISCRETE PEG MOLECULES AS ANALYTES FOR MS CALIBRATION AND TUNING IN POSITIVE AND NEGATIVE MODES

(71) Applicant: DH Technologies Development Pte. Ltd., Singapore (SG)

(72) Inventors: Subhasish Purkayastha, Framingham, MA (US); Subhakar Dey, Lexington, MA (US)

(21) Appl. No.: 18/683,343

(22) PCT Filed: Aug. 11, 2022
(86) PCT No.: PCT/IB2022/057513

§ 371 Date: Feb. 13, 2024

Related U.S. Application Data
(60) Provisional application No. 63/233,949, filed on Aug. 17, 2021.

(51) Int. Cl. C08L 71/02; H01J 49/00

(52) U.S. Cl. CPC C08L 71/02; H01J 49/0009

(57) ABSTRACT

The disclosure provides compositions, methods, and kits that find use in calibrating a mass spectrometer, and can include one or more predetermined concentration(s) of one or more calibrant molecule(s) that comprise a polyethylene glycol (PEG) compounds that have a single functional group that can be ionized by an ion source, and a solvent for dissolving the calibrant molecule(s). The calibrant molecule(s) and compositions including them can be used in either positive or negative ionization mode, and can be used for calibrating a variety of mass spectrometers (e.g., APCI, ESI) operating in a variety of acquisition modes (e.g., MRM, MS/MS, etc.).

### RELATED APPLICATIONS

The present patent application claims the priority benefit of U.S. Provisional Patent Application Ser. No. 63/233,949, filed Aug. 17, 2021, the content of which is hereby incorporated by reference in its entirety into this disclosure.

### BACKGROUND

To achieve accuracy and reliability, mass spectrometers need to be calibrated. Although a variety of calibrant compositions and molecules have been used to calibrate mass spectrometers, many of them do not span a large mass range, do not work in both positive and negative ionization modes, and may not ionize or consistently ionize under different ion sources (e.g., in both electrospray (ESI) and atmospheric pressure ionization (APCI) modes). Thus, it is typical for calibration methods to rely and utilitize multiple sets of calibrant compounds that work either in positive or negative ion mode and either in ESI or APCI mode, and which can require frequent recalibration and delay in analysis.

### SUMMARY

In accordance some of the aspects and embodiments of the disclosure, a calibration composition for use in mass spectrometry is provided.

In an aspect, the disclosure relates to a composition comprising a first compound comprising a functional group that is ionizable under only positive mode ionization and a second compound comprising a functional group that is ionizable only under negative mode ionization, wherein the first and second compounds have different masses.

In an aspect, the disclosure relates to a composition comprising a plurality of discrete polyethylene glycol compounds (dPEGs), wherein the plurality of dPEGs comprises a functional group that is ionizable under only one of positive mode ionization or negative mode ionization, wherein the plurality of dPEGs comprise one or more (I) dPEG-amine derivatives, (II) dPEG-carboxylic acid derivatives, (III) dPEG-sulfonic acid derivatives, and/or (IV) dPEG-phenolic derivatives.

In some embodiments of this aspect, the composition comprises a plurality of dPEGs that are selected from the Formulas:

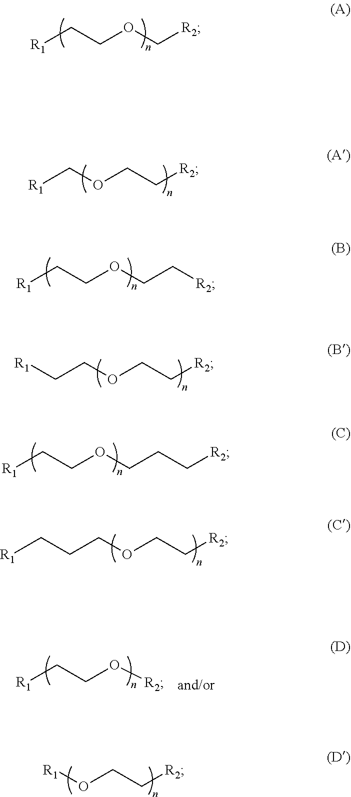

wherein R₂ is selected from an amine group, a carboxylic acid group, a sulfonic acid group, and a phenolic group; and wherein R₁ is selected from —H, —CH₃, —OH, —CH₂OH, —(CH₂)₂OH, —(CH₂)CCH, —CH₂N₃, —(CH₂)₂N₃, —NH₂, —CH₂NH₂, —(CH₂)₂NH₂, —CH₂SO₃H, and —(CH₂)₂SO₃H;

wherein when R₂ is an amine, R₁ is selected from —H, —CH₃, —CH₂OH, —(CH₂)₂OH, —(CH₂)CCH, —NH₂, —CH₂NH₂, and —(CH₂)₂NH₂.

wherein when R₂ is a carboxylic acid, a sulfonic acid, or a phenolic group, R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and

wherein n is in a range from 1-50.

In some further embodiments the plurality of dPEGs in the calibrant composition can comprise an R₂ group that comprises one of the following structures:

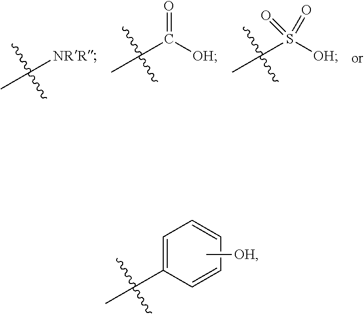

wherein R′ and R″ are independently selected from —H, and C₁-C₄ alkyl.

In some further embodiments, the plurality of dPEGs in the composition can comprise R₁, R₂, R′, R″, and n as defined above, but with the proviso that when R₁ is bound to oxygen it is not selected from —OH or —NH₂ (e.g., to avoid potentially zwitterionic compounds).

In yet further embodiments, the plurality of dPEGs in the composition can comprise R₁, R₂, R′, R″, and n as defined above, but with the proviso that when R₂ is bound to oxygen it is not amine or sulfonic acid (e.g., to avoid potentially zwitterionic compounds).

In some further embodiments, the plurality of dPEGs in the composition can comprise an n in the Formulas that is selected from 2-25.

In some embodiments, the plurality of dPEGs in the composition can comprise one or more PEG-amine derivatives selected from the following structures:

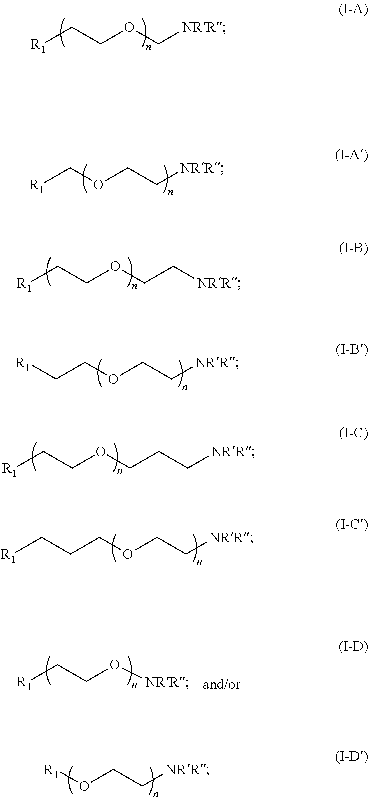

wherein R′ and R″ are independently selected from —H, and C₁-C₄ alkyl; wherein R₁ is selected from —H, —CH₃, —CH₂OH, —(CH₂)₂OH, —(CH₂)CCH, —NH₂, —CH₂NH₂, and —(CH₂)₂NH₂; and wherein n is from 1-50. In further embodiments, one or both of R′and R″ are H.

In some other embodiments, the plurality of dPEGs in the composition can comprise one or more dPEG-carboxylic acid derivatives selected from the following structures:

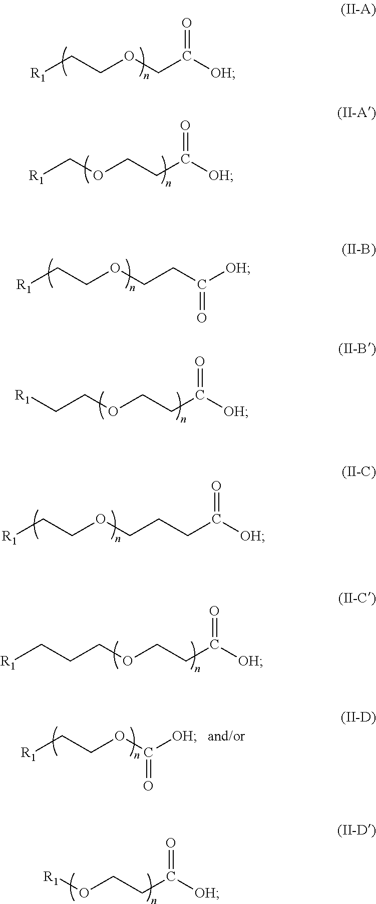

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

In some embodiments, the plurality of dPEGs in the composition can comprise one or more dPEG-sulfonic acid derivatives selected from the following structures:

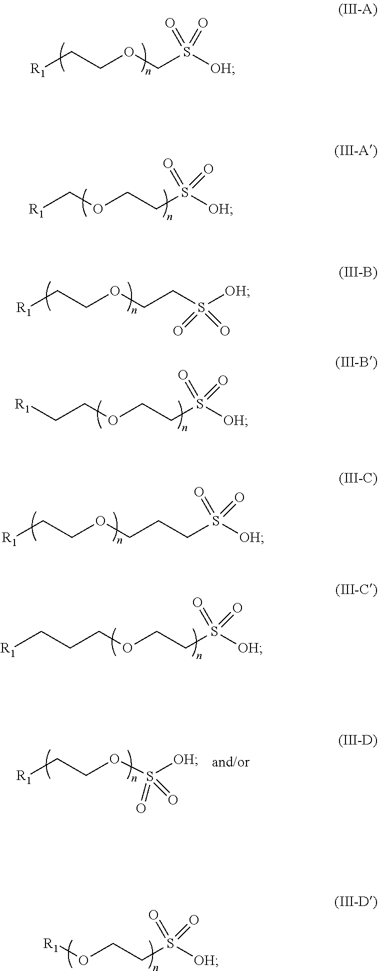

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

In some embodiments, the plurality of dPEGs in the composition can comprise one or more dPEG-phenolic derivatives selected from the following structures:

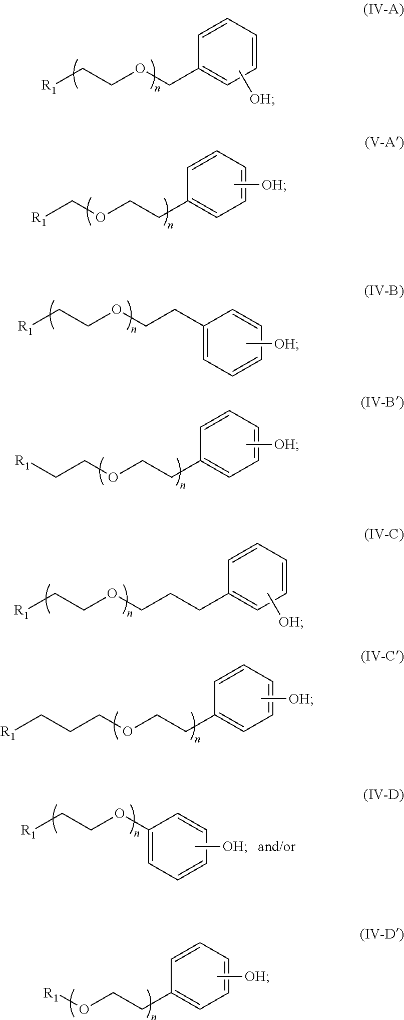

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

In variations of the above aspects and embodiments the composition can comprise a plurality of dPEG derivatives as disclosed above, in various combinations and permutations. In some embodiments of these variations, the plurality of dPEGs can be selected from:
(i) a plurality of dPEG-amine derivatives according to Formulas (I-A, I-A′, I-B, I-B′, I-C, I-C′, I-D, and I-D′) and a plurality of dPEG-carboxylic acid derivatives according to Formulas (II-A, II-A′, II-B, II-B′, II-C, II-C′, II-D, and II-D′);
(ii) a plurality of dPEG-amine derivatives according to Formulas (I-A, I-A′, I-B, I-B′, I-C, I-C′, I-D, and I-D′) and a plurality of dPEG-sulfonic acid derivatives according to Formulas (III-A, III-A′, III-B, III-B′, III-C, III-C′, III-D, and III-D′);
(iii) a plurality of dPEG-amine derivatives according to Formulas (I-A, I-A′, I-B, I-B′, I-C, I-C′, I-D, and I-D′) and a plurality of dPEG-phenolic acid derivatives according to Formulas (IV-A, IV-A′, IV-B, IV-B′, IV-C, IV-C′, IV-D, and IV-D′);
(iv) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), and at least one dPEG-sulfonic acid derivative according to Formulas (III-A, III-A′, III-B, III-B′, III-C, III-C′, III-D, and III-D′);
(v) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), and at least one dPEG-phenolic acid derivative according to Formulas (IV-A, IV-A′, IV-B, IV-B′, IV-C, IV-C′, IV-D, and IV-D′);
(vi) a plurality of dPEG-amine derivatives according to Formulas (I-A, I-A′, I-B, I-B′, I-C, I-C′, I-D, and I-D′), at least one dPEG-sulfonic acid derivative according to Formulas (III-A, III-A′, III-B, III-B′, III-C, III-C′, III-D, and III-D′), and at least one dPEG-carboxylic acid derivative according to Formulas (II-A, II-A′, II-B, II-B′, II-C, II-C′, II-D, and II-D′);
(vii) a plurality of dPEG-amine derivatives according to Formulas (I-A, I-A′, I-B, I-B′, I-C, I-C′, I-D, and I-D′), at least one dPEG-sulfonic acid derivative according to Formulas (III-A, III-A′, III-B, III-B′, III-C, III-C′, III-D, and III-D′), and at least one dPEG-phenolic acid derivative according to Formulas (IV-A, IV-A′, IV-B, IV-B′, IV-C, IV-C′, IV-D, and IV-D′);
(viii) a plurality of dPEG-amine derivatives according to Formulas (I-A, I-A′, I-B, I-B′, I-C, I-C′, I-D, and I-D′), at least one dPEG-phenolic acid derivative according to Formulas (IV-A, IV-A′, IV-B, IV-B′, IV-C, IV-C′, IV-D, and IV-D′), and at least one dPEG-carboxylic acid derivative according to Formulas (II-A, II-A′, II-B, II-B′, II-C, II-C′, II-D, and II-D′);
(ix) a plurality of dPEG-amine derivatives according to Formulas (I-A, I-A′, I-B, I-B′, I-C, I-C′, I-D, and I-D′), at least one dPEG-phenolic acid derivative according to Formulas (IV-A, IV-A′, IV-B, IV-B′, IV-C, IV-C′, IV-D, and IV-D′), and at least one dPEG-sulfonic acid derivative according to Formulas (III-A, III-A′, III-B, III-B′, III-C, III-C′, III-D, and III-D′); and
(x) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), at least one dPEG-sulfonic acid derivative according to Formulas (III-A, III-A′, III-B, III-B′, III-C, III-C′, III-D, and III-D′), and at least one dPEG-phenolic acid derivative according to Formulas (IV-A, IV-A′, IV-B, IV-B′, IV-C, IV-C′, IV-D, and IV-D′).

In another aspect, the disclosure provides a kit comprising (A) at least one calibrant composition comprising a plurality of dPEGs according to any of the aspects and embodiments described herein; (B) a solvent; and (C) instructions for use.

In another aspect, the disclosure provides for methods for calibrating a mass spectrometer. In various embodiments, a method in accordance with the disclosure comprises: a) obtaining a mass spectrum of at least one calibrant composition comprising a plurality of dPEGs, or a kit comprising at least one calibrant composition, according to any of the aspects and embodiments described herein; b) determining the differences between the expected mass peaks for the plurality of dPEG derivatives in the composition, and the corresponding actual mass peaks in the mass spectrum; and c) adjusting the mass spectrometer based on the differences between the expected mass peaks and the actual mass peaks.

In some embodiments of this aspect, the method can be used to calibrate a mass spectrometer operating in positive ionization mode or negative ionization mode.

In some embodiments of this aspect, the method further comprises determining the differences between an expected intensity for one or more of the plurality of dPEG derivatives in the composition, and the corresponding actual intensity of the one or more of the plurality of dPEG derivatives in the mass spectrum, wherein the expected intensity is determined from a known concentration of the one or more of the plurality of dPEG derivatives, and adjusting the mass spectrometer based on the differences between the expected intensity and the actual intensity in the mass spectrum.

In some embodiments of this aspect, the method may be used to calibrate any mass spectrometer such as, for example, an ESI spectrometer, an APCI mass spectrometer, or a MALDI mass spectrometer. In some further embodiments, the method is used to calibrate an APCI or and ESI mass spectrometer.

In some embodiments, the method is performed under MS/MS acquisition mode. In such embodiments, a mass filter may be applied to isolate a species (i.e., calibrant molecule(s)) of a particular mass and perform additional mass analysis on one or more fragments of that species (i.e., MS and MS/MS analysis).

In some embodiments, the method may be performed over the full mass range window. In some other embodiments, the method may be performed over one or a series of sequential mass range windows that fall within, but does not cover, the entire mass range window that is scanned.

In some embodiments, the method is effective to calibrate a mass spectrometer across a mass range of about 100 to 3500 Da, or about 100 to 3000 Da, or about 100 to 2500 Da, or about 100 to 2400 Da, or about 100 to 2300 Da, or about 100 to 2200 Da, or about 100 to 2100 Da, or about 100 to 2000 Da, or within a narrower mass range that falls within any of the above ranges (e.g., about 500-1000 Da, 250-1500 Da, 750-2500 Da, etc.).

These and other features, aspects, embodiments, and advantages provided by the disclosure will be apparent to one of ordinary skill in view of the following description.

### BRIEF DESCRIPTION OF THE DRAWINGS

The skilled person in the art will understand that the Figures, described below, are for illustration purposes only and do not serve to limit the scope of the description or appended claims in any way.

FIG. 1 shows the molecular structure of some non-limiting embodiments of discrete polyethylene glycol compounds that are ionizable in positive mode ionization in accordance with various example embodiments of the disclosure.

FIG. 2 shows the molecular structure of some non-limiting embodiments of discrete polyethylene glycol compounds that are ionizable in negative mode ionization in accordance with various example embodiments of the disclosure.

FIGS. 3A-3B depicts an example embodiment of a calibrant composition MS in negative mode. FIG. 3A shows mass spectra four components of a calibrant composition obtained using a mass spectrometer with an APCI ion source in negative ionization mode in accordance example embodiments of the disclosure. FIG. 3B depicts the spectrum of the calibrant composition with an inset spectrum of ethansulfonic acid (at 20 μM, 110.1 mol wt).

FIGS. 4A-4B depicts an example embodiment of a calibrant composition MS in positive mode. FIG. 4A shows mass spectra for four components of a calibrant composition obtained using a mass spectrometer with an APCI ion source in positive ionization mode in accordance example embodiments of the disclosure. FIG. 4B depicts the spectrum of the calibrant composition with an inset spectrum of dimethylamine (at 10 μM, 45.0 mol wt).

### DETAILED DESCRIPTION

It should be understood that the phrase “a” or “an” used in conjunction with the applicants' teachings with reference to various elements encompasses “one or more” or “at least one” unless the context clearly indicates otherwise.

### Compositions

In an aspect the disclosure provides a calibration composition (or “calibrant composition”) for mass spec analysis, comprising a known amount of at least one calibrant molecule that comprises at least one discrete polyethylene glycol (dPEG) compound in a solvent that can solubilize the dPEG, and any other components that can be present in the composition. In various embodiments, the calibrant composition can be used to calibrate a mass spec operating in positive or negative ionization mode. In various embodiments, the calibrant composition can be used in calibrating a mass spectrometer with an atmospheric pressure chemical ionization (APCI) mass spectrometer or a mass spectrometer with an electrospray (ESI) ion source. In various embodiments, a calibrant composition can be selected to enable calibration across a broad mass range and can provide reference mass peaks in both positive and negative ionization modes. In various aspects, substantially the same components can be used for both APCI and electrospray mass spectrometry. To provide calibration across a broad mass range, the calibrant composition can comprise a mixture of different discrete polyethylene glycol compounds in accordance with various embodiments of the disclosure. In various example embodiments, the calibrant composition can enable calibration across a mass range of approximately 100 to 3500 Da or, in some aspects, from about 100 Da to about 2500 Da. In embodiments, the calibration provides for linear or substantially linear mass calibration over the entire mass range being analyzed.

The compositions, kits, and methods described herein provide for certain advantages relative to other calibration compositions and methods that find common use in the art. For example, in accordance with various aspects and embodiments of the disclosure, the calibrant compositions provided herein can provide for better accuracy, sensitivity, and consistency in performance that calibration compositions that comprise zwitterionic molecules as a calibrant. The dPEGs disclosed herein, and the compositions, kits, and methods comprising them provide for improved ionization and mass signal and sensitivity that is consistent across all ion source types and acquisition modes. Thus, the compositions, kits, and methods provide for more consistent calibration results regardless of the type of ion source and ionization mode (in both positive and negative mode).

In some embodiments, the composition may comprise a plurality of discrete polyethylene glycols (dPEGs) that comprise a functional group that is ionizable under only one of positive mode ionization or negative mode ionization. In non-limiting embodiments the plurality of dPEGs comprise one or more (I) PEG-amine derivative, (II) PEG-carboxylic acid derivative, (III) PEG-phenolic derivative, and/or (IV) PEG-sulfonic acid derivative. In such non-limiting embodiments, the plurality of dPEGs may be selected from the Formulas:

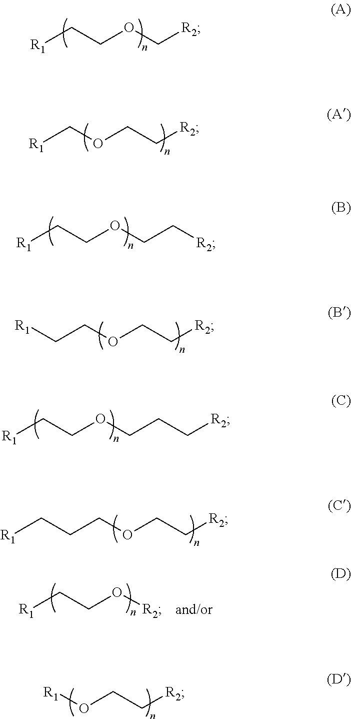

wherein R₂ is selected from an amine group, a carboxylic acid group, a sulfonic acid group, and a phenolic group; and wherein R₁ is selected from —H, —CH₃, —OH, —CH₂OH, —(CH₂)₂OH, —(CH₂)CCH, —CH₂N₃, —(CH₂)₂N₃, —NH₂, —CH₂NH₂, —(CH₂)₂NH₂, —CH₂SO₃H, and —(CH₂)₂SO₃H;

wherein when R₂ is an amine, R₁ is selected from —H, —CH₃, —CH₂OH, —(CH₂)₂OH, —(CH₂)CCH, —NH₂, —CH₂NH₂, and —(CH₂)₂NH₂;

wherein when R₂ is a carboxylic acid, a sulfonic acid, or a phenolic group, R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and

wherein n is from 1 to about 75, or from 1 to about 45-50, or from about 1 to about 25.

In some embodiments, the dPEGs are of the above Formulas with one or more provisos wherein if R₁ is bound directly to oxygen it is not selected from —OH or —NH₂; and/or wherein if R₂ is bound directly to oxygen it is not amine; carboxylic acid; or sulfonic acid (e.g., in order to avoid compounds that may be present, or ionize, as zwitterions).

Positive Ionization Mode dPEGs

In some example embodiments in accordance with the disclosure, the dPEGs may be ionizable in positive mode ionization and comprise an amine group. In some non-limiting embodiments, the plurality of dPEGs may comprise one or more of the following structures:

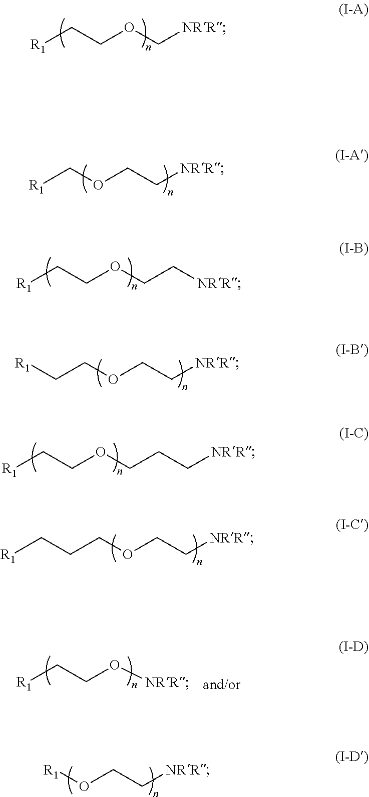

wherein R′ and R″ are independently selected from —H, and C₁-C₄ alkyl; wherein R₁ is selected from —H, —CH₃, —CH₂OH, —(CH₂)₂OH, —(CH₂)CCH, —NH₂, —CH₂NH₂, and —(CH₂)₂NH₂; and wherein n is from 1 to about 75, or from 1 to about 45-50, or from about 1 to about 25.

In some example embodiments in accordance with the disclosure, at least one of the R′ and R″ are H. In some further example embodiments both R′ and R″ are H.

In some further example embodiments, the calibrant composition may comprise one or more amino dPEGs according to I-A, I-B, I-C, I-A′, I-B′, or I-C′.

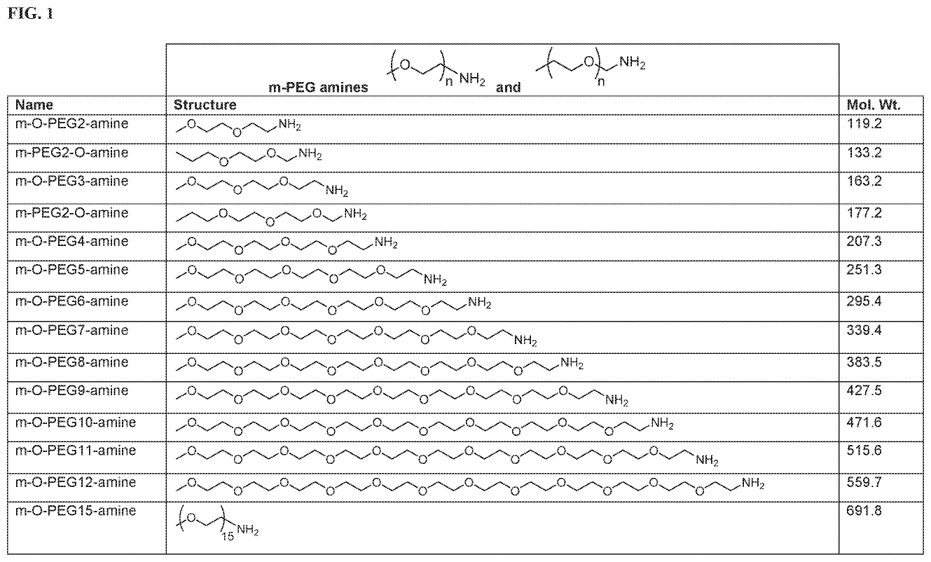

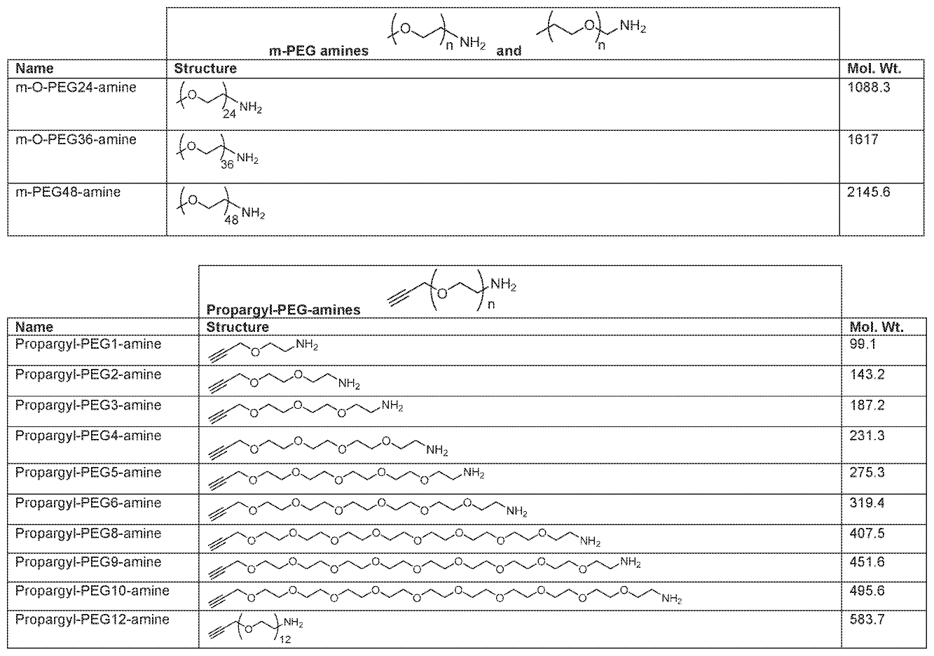

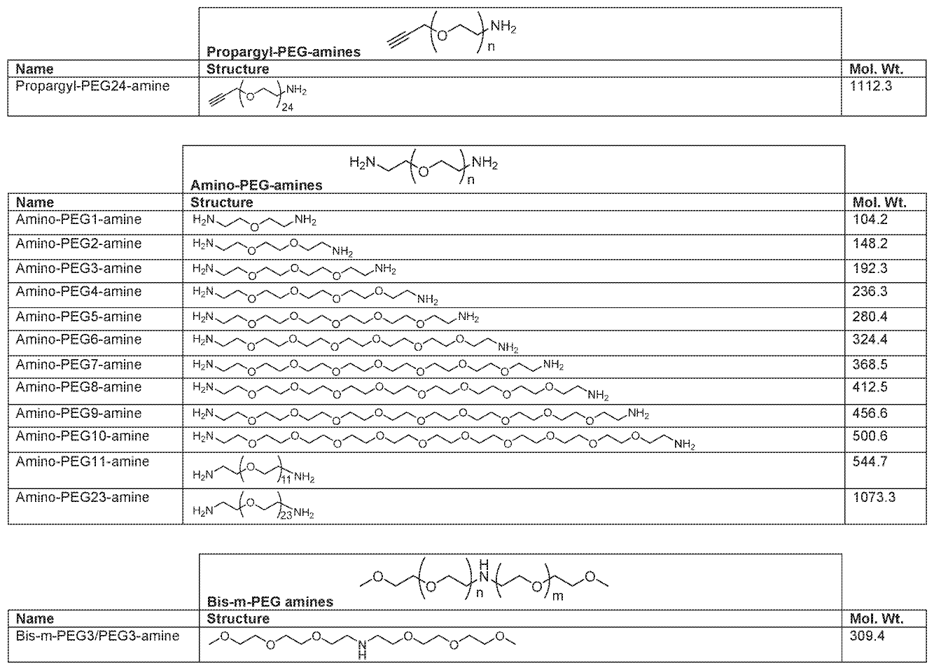

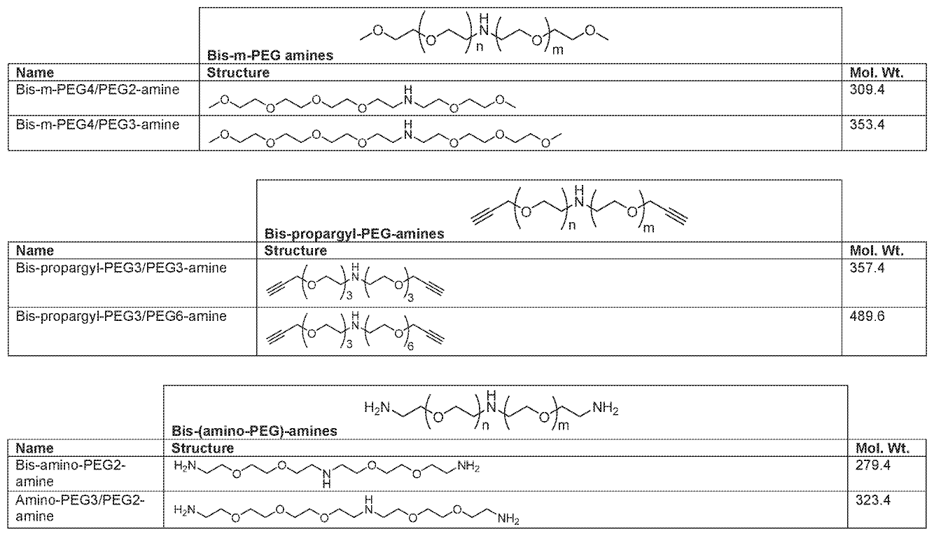

In yet some further embodiments, the calibrant composition may comprise one or more amino dPEGs as depicted in FIG. 1.

Negative Ionization Mode dPEGs

In some example embodiments in accordance with the disclosure, the dPEGs may be ionizable in negative mode ionization and comprise a carboxylic acid group. In some non-limiting embodiments, the plurality of dPEGs may comprise one or more of the following structures:

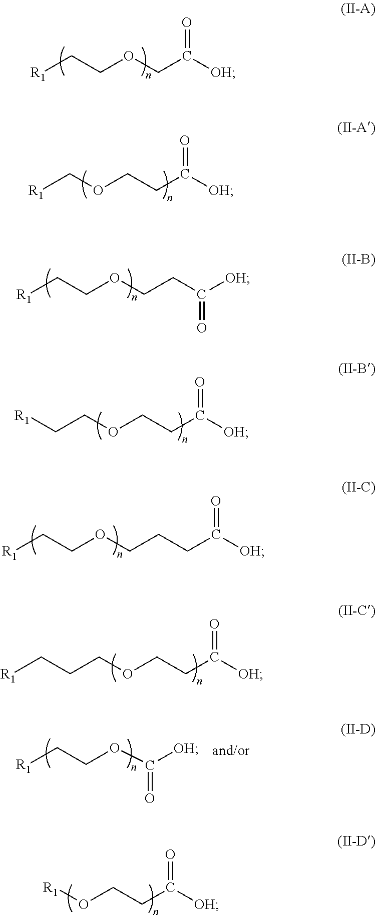

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1 to about 75, or from 1 to about 45-50, or from about 1 to about 25.

In some example embodiments, the calibrant composition may comprise one or more carboxylic acid dPEGs according to II-A, II-B, II-C, II-A′, II-B′, or II-C′.

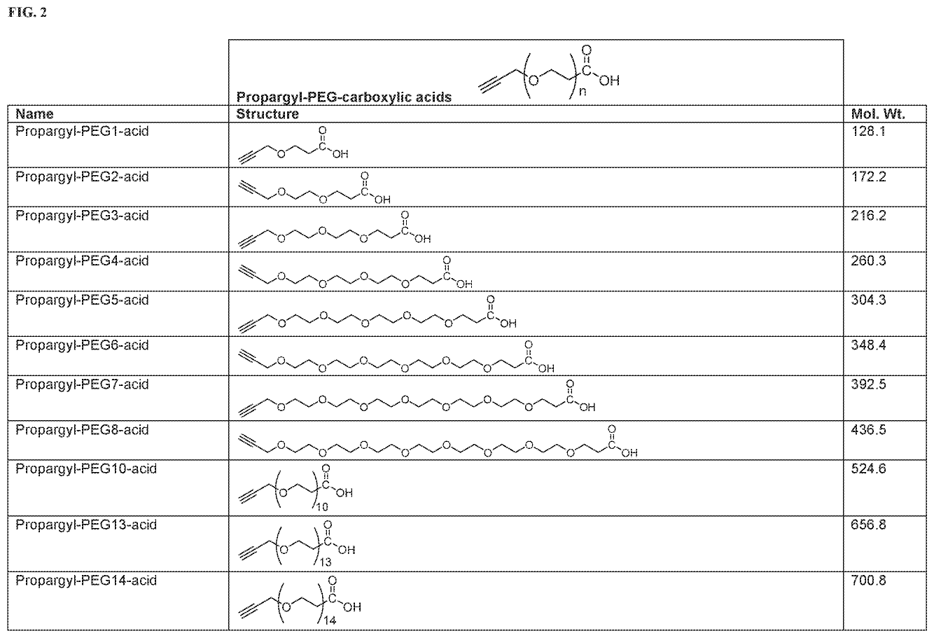

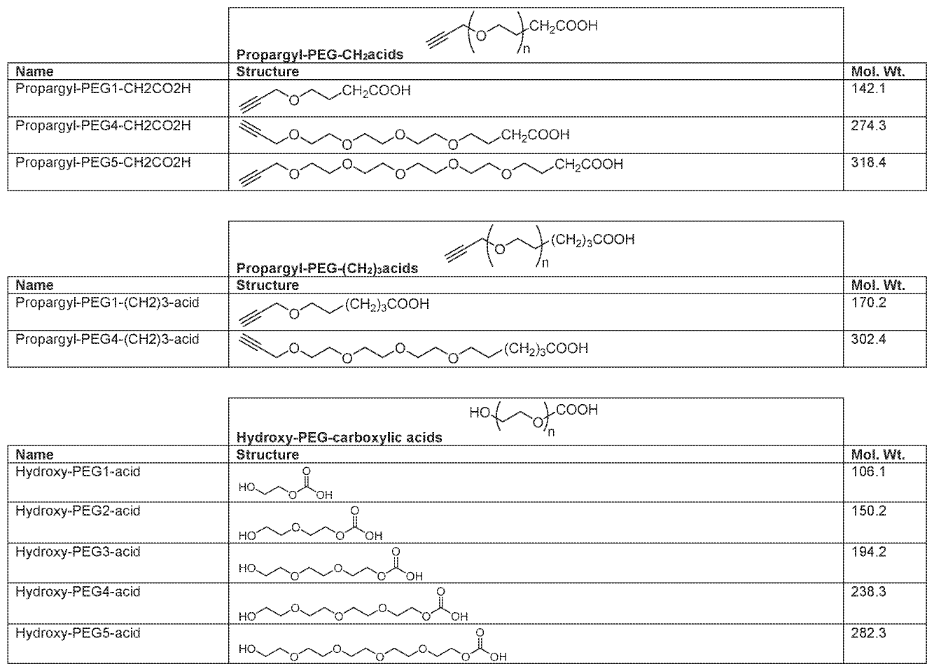

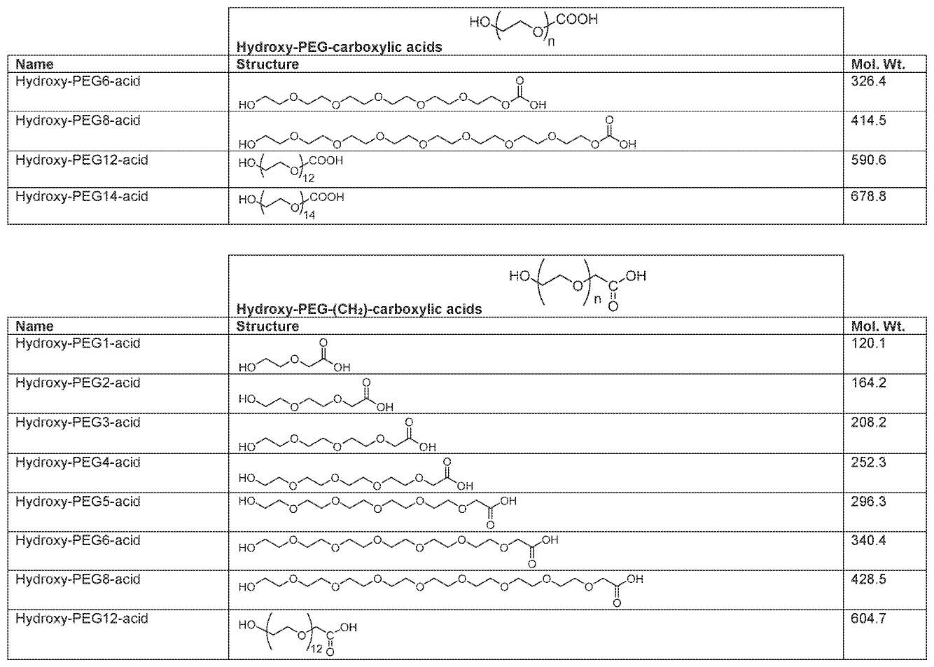

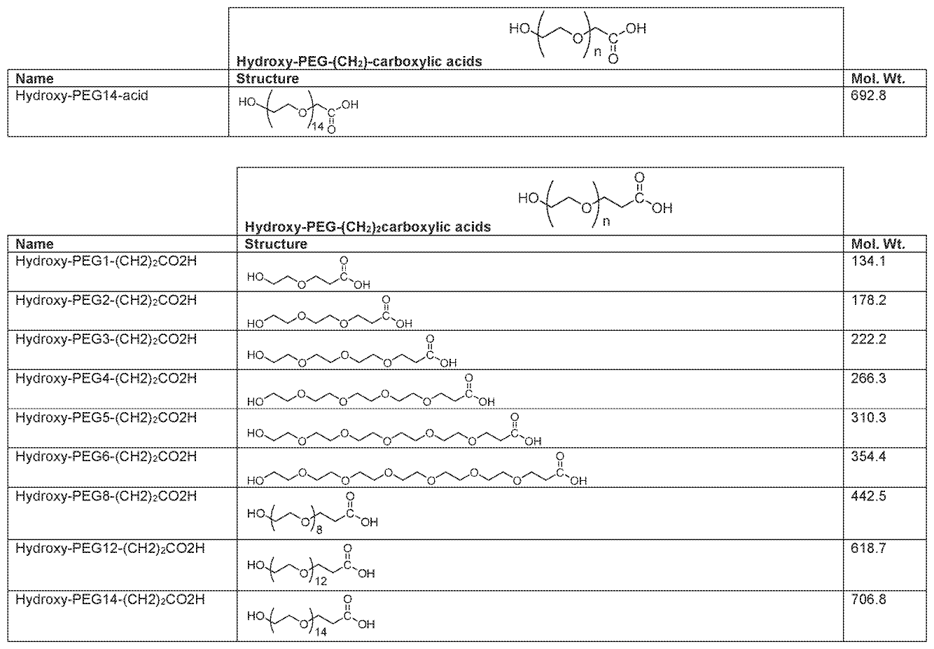

In yet some further embodiments, the calibrant composition may comprise one or more carboxylic acid dPEGs as depicted in FIG. 2.

In some example embodiments in accordance with the disclosure, the dPEGs may be ionizable in negative mode ionization and comprise a sulfonic acid group. In some non-limiting embodiments, the plurality of dPEGs may comprise one or more of the following structures:

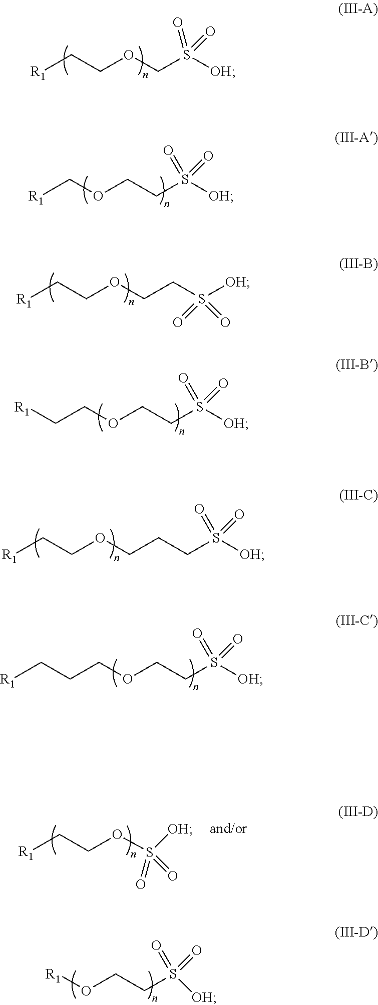

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1 to about 75, or from 1 to about 45-50, or from about 1 to about 25.

In some example embodiments, the calibrant composition may comprise one or more sulfonic acid dPEGs according to III-A, III-B, III-C, III-A′, III-B′, or III-C′.

In yet some further embodiments, the calibrant composition may comprise one or more sulfonic acid dPEGs as depicted in FIG. 2.

In some example embodiments in accordance with the disclosure, the dPEGs may be ionizable in negative mode ionization and comprise a phenolic group. In some non-limiting embodiments, the plurality of dPEGs may comprise one or more of the following structures:

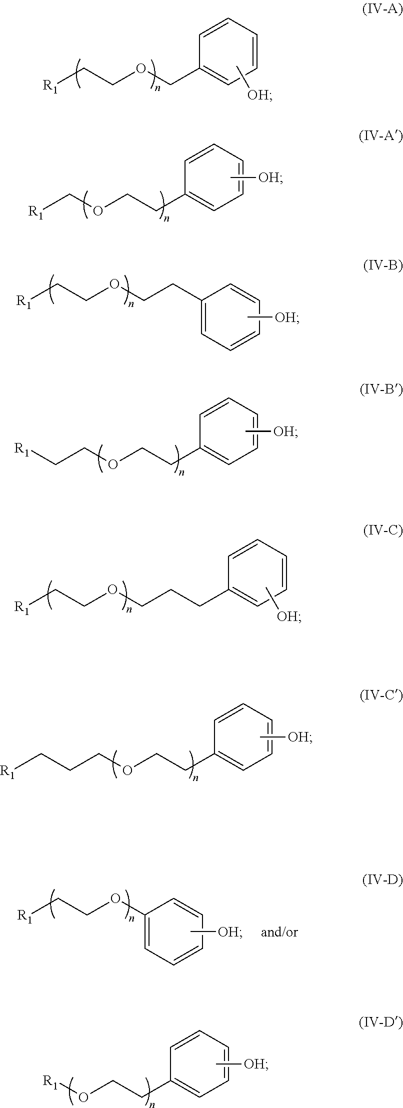

wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1 to about 75, or from 1 to about 45-50, or from about 1 to about 25.

In some example embodiments, the calibrant composition may comprise one or more phenolic dPEGs according to IV-A, IV-B, IV-C, IV-A′, IV-B′, or IV-C′.

In yet some further embodiments, the calibrant composition may comprise one or more carboxylic acid dPEGs as depicted in FIG. 2.

As discussed above, FIGS. 1-2 depict exemplary molecular structures of discrete polyethylene glycol compounds (dPEG derivatives), and the calibrant compositions in accordance with various example embodiments of the disclosure can comprise one or a plurality of the amine, carboxylic acid, sulfonic acid, and phenolic dPEGs shown in FIGS. 1-2. In various embodiments, the calibrant composition can include, but is not limited to, one or a plurality of the dPEGs shown in FIG. 1. In various embodiments, the calibrant composition can include, but is not limited to, one or a plurality of the dPEGs shown in FIG. 2. In various embodiments, the calibrant composition can include, but is not limited to, a plurality of the dPEGs shown in FIG. 1. In various embodiments, the calibrant composition can include, but is not limited to, a plurality of the dPEGs shown in FIG. 2. In various embodiments, the calibrant composition can comprise a mixture of dPEGs comprising a plurality of the dPEGs shown in FIGS. 1-2. Thus, in various embodiments, the composition can comprise one or a plurality of dPEGs having an amino group on one end, a number of ethylene oxide units, and a methyl, propargyl, hydroxyl, amino, or azido group on the other end, known also as amino-dPEGn derivatives, wherein n is the number of ethylene oxide units. For example, m-PEG4 amine has a methyl group on one end, four ethylene oxide units, and a primary amine group on the other end, with a calculated molecular weight of 207.3, as shown in

FIG. 1. In various embodiments, the composition can also comprise one or a plurality of dPEGs having a carboxylic acid group, a sulfonic acid group, and/or a phenolic group on one end, a number of ethylene oxide units, and a methyl, propargyl, carboxylate, sulfonate, hydroxy, or azido group on the other end, (i.e., carboxylic acid-dPEGn derivatives, sulfonic acid-dPEGn derivatives, phenolic-dPEGn derivatives) wherein n is the number of ethylene oxide units. For example, m-PEG4 carboxlyic acid has a methyl group on one end, four ethylene oxide units, and a carboxylic acid group on the other end, with a calculated molecular weight of 236.3, as shown in FIG. 2.

In various embodiments, the calibrant composition comprises a mixture of different dPEG-derivatives that can be selected to span a broad mass range, or a desired and more defined mass range. In various embodiments, two, three, four, or five or more dPEG-derivative compounds can be used in the calibration composition. For example, a calibration composition can include two, three, four, or five or more dPEGs that are ionizable under negative mode ionization and two, three, four, or five or more dPEGs that are ionizable under positive mode ionization.

In some embodiments, one or more of the dPEGs used in a calibrant composition can comprise one or more atomic isotopes that provide for a difference in relative or expected atomic mass. In such embodiments, the calibrant composition can comprise two dPEGs that have the same chemical formula but wherein one of the dPEGs comprises one or more different atomic isotopes. In embodiments, the relative ratio of the amount of the atomic isotope (i.e., the degree of isotopic enrichment) is known. In further embodiments, the amount of the isotopically enriched dPEG and the amount of the non-enriched dPEG are both known. Such compositions can be used, for example, in methods for detecting the presence or absence of an isotope in a sample for analysis.

The various dPEG-derivative compounds can be obtained from any commercially available sources, or they may be synthesized using synthetic methods known in the art. Commercially available sources of such compounds and/or custom synthesis are known in the art. In accordance with the disclosure, the compositions disclosed herein may be prepared by mixing known amounts of various dPEGn-derivative compounds in a container and/or with an optional solvent.

In yet further embodiments, the calibration composition may further comprise additional molecules and/or solutions that are known and available for use in mass spec calibration. Such additional molecules and compositions may include fluorinated species such as, for example fluorinated aromatics, aromatic heterocycles (e.g., triazines), organophosphates (e.g., phosphazenes) are available, for example, from sources such as Thermo Scientific Pierce and Aglient. Other non-limiting examples of such additional molecules include, but are not limited to, 7-aminoheptanoic acid (Sigma-Aldrich), clomipramine (Sigma-Aldrich), reserpine (Sigma-Aldrich), phosphazene 921 (Apollo Scientific Ltd.), phosphazene, 1521 (Apollo Scientific Ltd.), and sulfinpyrazone (Sigma-Aldrich).

### Solvents

In example embodiments in accordance with the disclosure the compositions comprise a solvent to dissolve the calibrant dPEGs and can comprise aqueous or organic solvents. In some embodiments the solvent can comprise water, organic solvents, or mixtures thereof (e.g., mixtures of miscible organic solvents or water with miscible organic solvents). In some further embodiments, non-limiting examples of solvents include water, and organic solvents such as acetonitrile, methanol, ethanol, propanol, isopropanol, butanol, dichloromethane, acetone, toluene, benzene, chloroform, dimethylformamide, organic acids (e.g., acetic acid), amines (e.g., dimethyl amine), or aqueous dilutions/combinations thereof. In some further embodiments, the solvent can comprise water, methanol, ethanol, acetonitrile, dichloromethane, acetone, organic acids, or amines, or combinations thereof. In yet further embodiments, the solvent can comprise a mixture of acetonitrile and water; acetone and water; ethanol and water; methanol and water; dilute formic acid; dilute acetic acid; or dilute dimethylamine.

The calibrant compositions in accordance with the aspect and embodiments disclosed herein have good stability (shelf-and shipping-stable) and can remain stable for weeks at ambient temperatures (e.g., 5 weeks at 25° C.). The dPEG-derivatives may be stored in individual containers as separate compositions, and mixed immediately prior to performing mass spec calibration. Once prepared, the calibrant compositions may be stored at reduced temperature (e.g., 4° C. or other refrigerated/freezing temperatures) to help prolong composition stability.

### Methods

In various aspects, the disclosure provides methods for calibrating, optimizing, and tuning parameters of a mass spectrometer to ensure and/or increase the accuracy of mass spectroscopy analysis. In some embodiments the method comprises obtaining at least one mass spectrum of a plurality of dPEG derivatives and/or a calibration composition as disclosed herein. In some embodiments the method comprises obtaining at least one mass spectrum of a calibrant composition as mass standards, for example an internal or external standard. In some embodiments, the method comprises a calibrant composition as an internal standard. In some embodiments, the method comprises a calibrant composition as an external standard. In performing a method in accordance with the aspects and embodiments of the disclosure, the differences between the expected mass peaks for the known dPEGs and the corresponding mass peaks obtained can be determined and the mass spectrometer can be adjusted based on the differences between the expected and actual mass peaks. In various embodiments, the method comprises acquiring a mass spectrum of a calibrant composition on a mass spectrometer that is operating in either positive or negative ionization mode. In some embodiments, the methods comprise calibrating an APCI or an electrospray mass spectrometer.

In some embodiments, the methods can comprise one or more calibration compositions having different concentrations, or various dilutions of a calibration composition. In such embodiments, the method can comprise calibrating mass spec based on the acquired signal intensity and the expected signal intensity based on dPEG derivative concentration(s). In related embodiments the calibrant compositions may be diluted when used in methods for calibrating mass spectrometers capable of detecting low level analytes (e.g., high-sensitive instrumentation such as the Triple Quad 7500 System from Sciex).

In some embodiments, the methods can comprise an autotune program or other similar type of automated MS acquisition application that may be included with mass spec operational software.

In embodiments, the methods and compositions can be used to calibrate one or more quadrupoles and may be used in any variety of MS scanning modes including, for example, MS, MS/MS, product ion, precursor ion, neutral loss or gain, MRM, EMS, EPI, ER, MS3, or MRM3 scanning modes. For example, in such embodiments, the methods and compositions allow for calibration of single ion monitoring scans, full scans, mass-filter/fragmentation scans, and multiple reaction monitoring scans, among others.

The methods can comprise a calibrant composition comprising a plurality of known compounds comprising a mixture of dPEGs that can calibrate a variety of mass spec instruments that use various ion sources and that can operate in negative or positive ionization mode. In some embodiments the calibrant composition comprises at least one dPEG amine derivative and one or more of a dPEG-carboxylic acid derivative, a dPEG-sulfonic acid derivative, or a dPEG-phenolic derivative as the calibrant compounds. In some embodiments, the method comprises a calibrant composition comprises a dPEG amine compound, a dPEG-carboxylic acid compound, a dPEG-sulfonic acid compound, and a dPEG-phenolic compound. In embodiments the method comprises a calibrant composition that comprises a plurality (e.g., 2, 3, 4, or 5, etc.) of dPEG amine compounds, dPEG-carboxylic acid compounds, dPEG-sulfonic acid compounds, and dPEG-phenolic compounds.

In various embodiments, the methods can enable the calibration of a mass spectrometer across a broad range of masses, or narrower mass ranges within a broader range. In various embodiments, the methods enable accurate and consistent calibration across a mass range of approximately 100 to 3500 Da, or about 100 to 3000 Da, or about 100 to 2500 Da, or about 100 to 2400 Da, or about 100 to 2300 Da, or about 100 to 2200 Da, or about 100 to 2100 Da, or about 100 to 2000 Da, or within a narrower mass range that falls within any of the above ranges (e.g., about 500-1000 Da, 250-1500 Da, 750-2500 Da, etc. In some embodiments, the method comprises a calibrant composition comprising a plurality of dPEGs that create a molecular weight “ladder” that comprise molecular weights that span regular intervals within a defined mass range.

### Kits

In an aspect the disclosure provides, a kit comprising the compositions disclosed herein. In some embodiments, the kit may comprise a kit of parts that comprises, for example, a plurality of dPEGs as separate containers of individual dPEGs or as separate containers of combinations of one or more different dPEGs. In some embodiments the kit may comprise a plurality of dPEGs that are contained in single use container for calibrating a mass spectrometer. In embodiments, the kit can comprise a predetermined concentration of one or a plurality of dPEGs or a calibrant composition comprising a mixture of various dPEG derivatives in accordance with the disclosure, and a solvent for dissolving the dPEGs.

In various embodiments, the kits may be used in methods for calibrating a mass spectrometer such as, for example, an APCI or an ESI mass spectrometer. In such embodiments, the kits provide for such calibration in either the positive ionization mode or the negative ionization mode. In the aspects and embodiments relating to kits, the disclosure provides for any combination of one or more dPEGs in accordance with the (I) dPEG-amine derivatives, (II) dPEG-carboxylic acid derivatives, (III) dPEG-sulfonic acid derivatives, and/or (IV) dPEG-phenolic derivatives described herein.

In some embodiments, the kit can comprise a solvent that is effective to dissolve plurality of dPEGs and/or the calibrant composition. In such embodiments, the solvent can comprise any of suitable solvent or mixtures thereof in accordance with the disclosure and example embodiments provided herein.

In various embodiments, the kit comprises a plurality of dPEGs and/or a calibrant composition comprising a mixture of dPEG derivatives that provides for calibration of a mass spectrometer across a broad range of masses. In some embodiments, the kit can comprise a plurality of dPEGs and/or a calibrant composition that can enable calibration across a range of approximately 100 to 3500 Da, or in some embodiments from about 100 to about 2500 Da, in either positive ionization mode or negative ionization mode.

### EXAMPLES

### Example 1A. Calibrant Composition in Negative Mode Acquisition

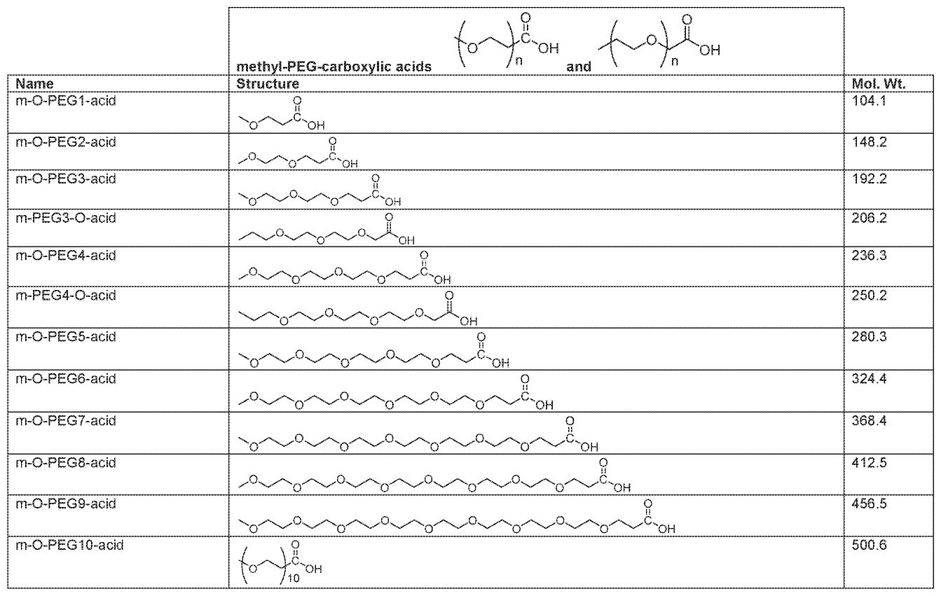

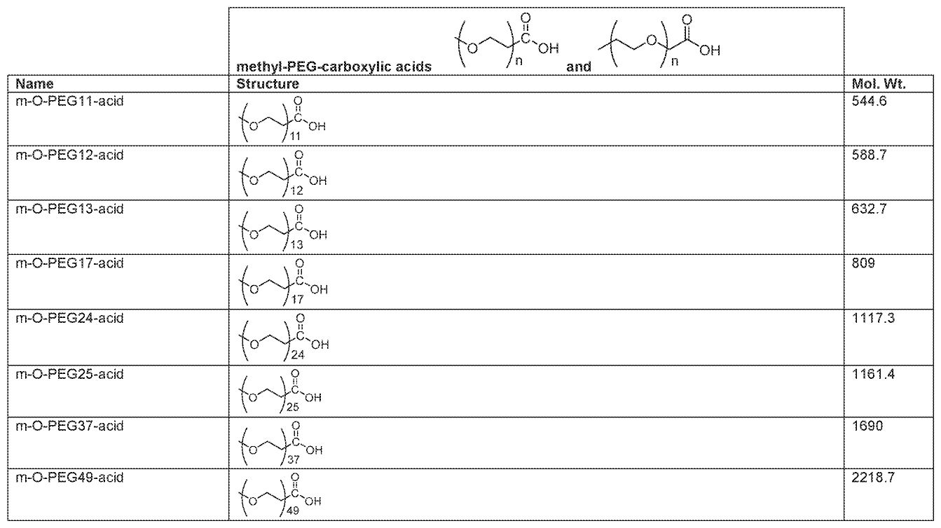

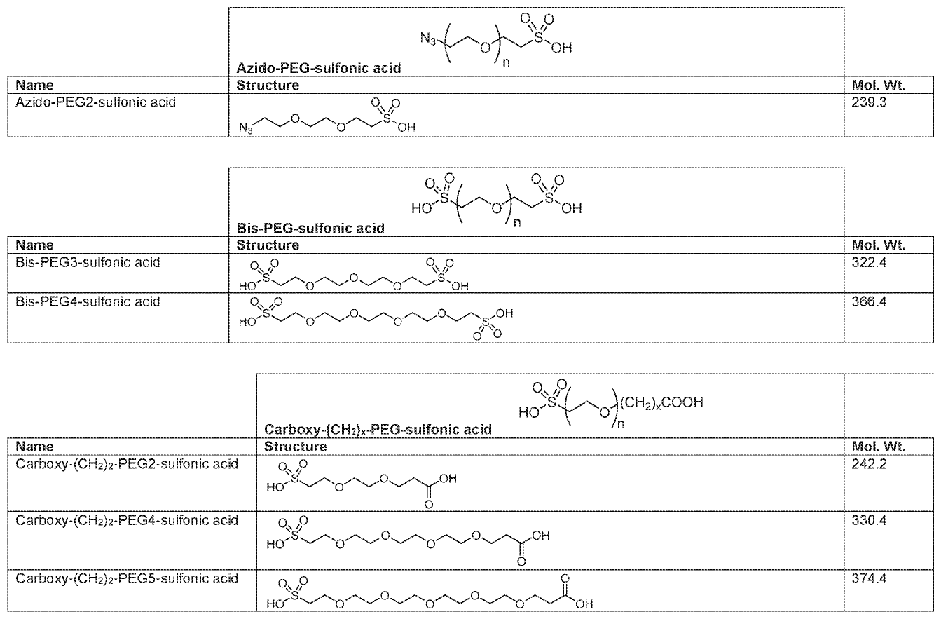

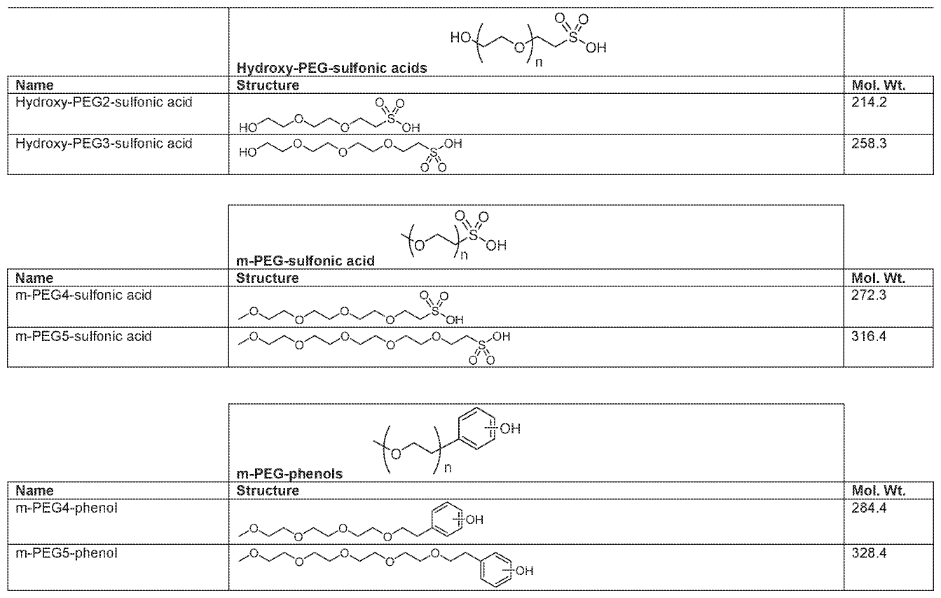

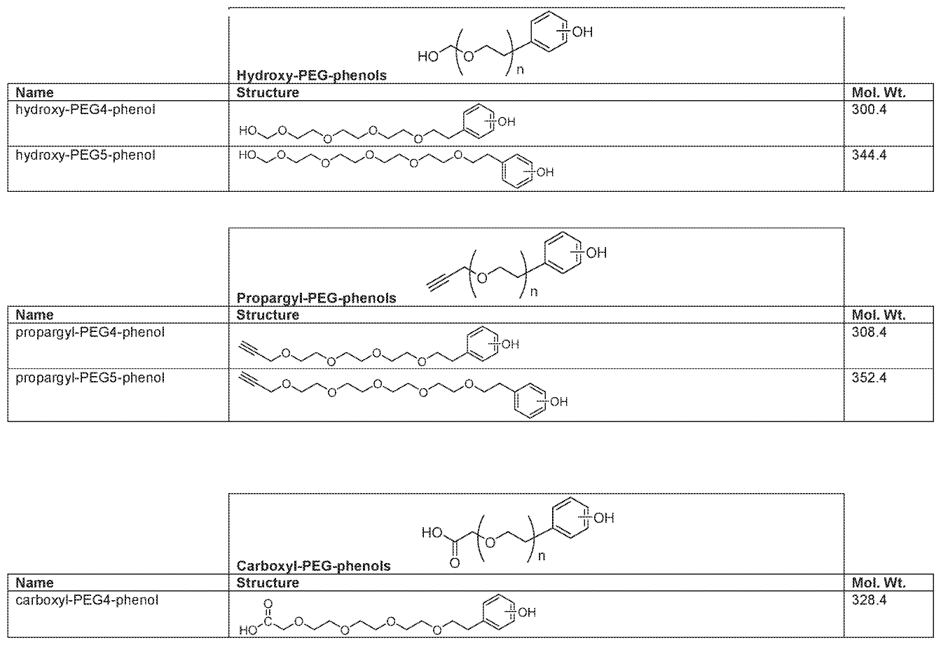

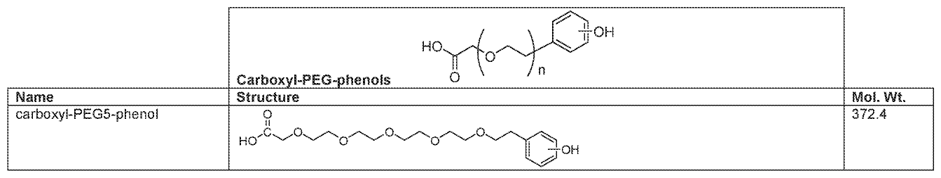

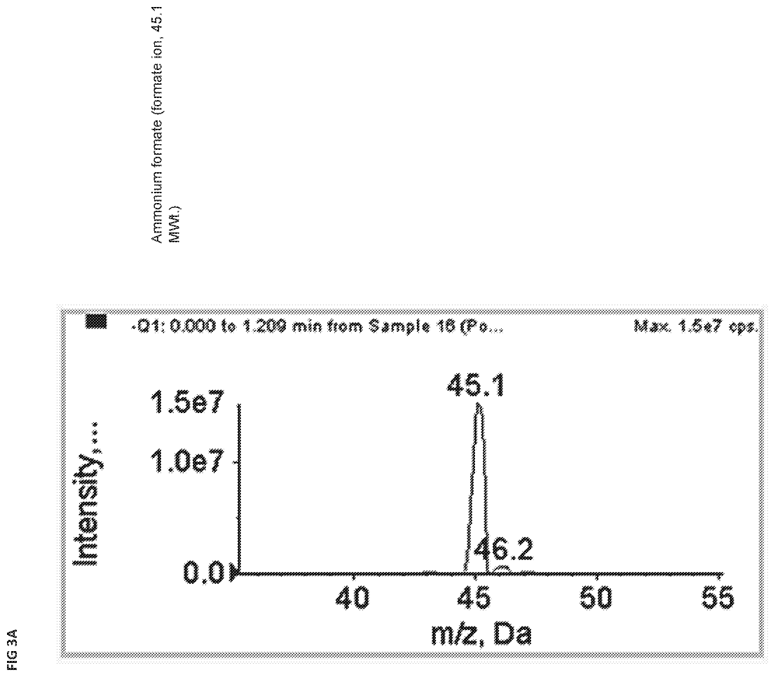

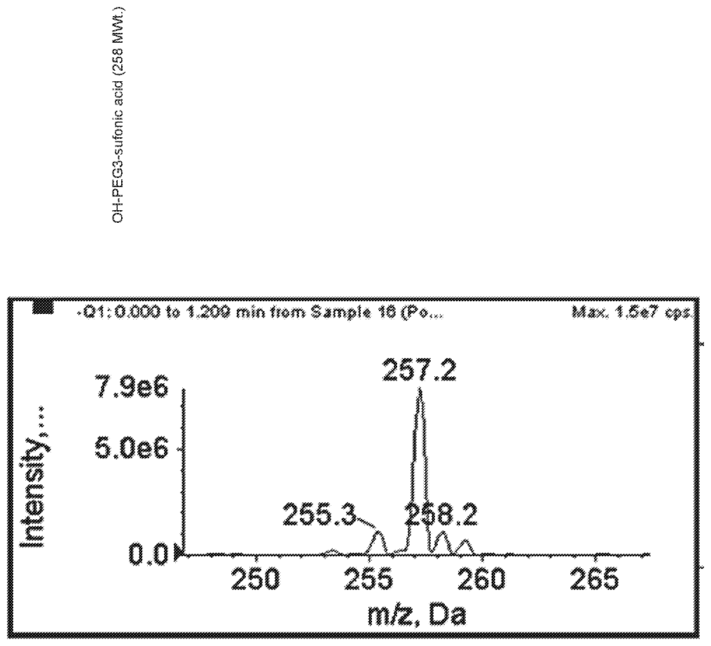

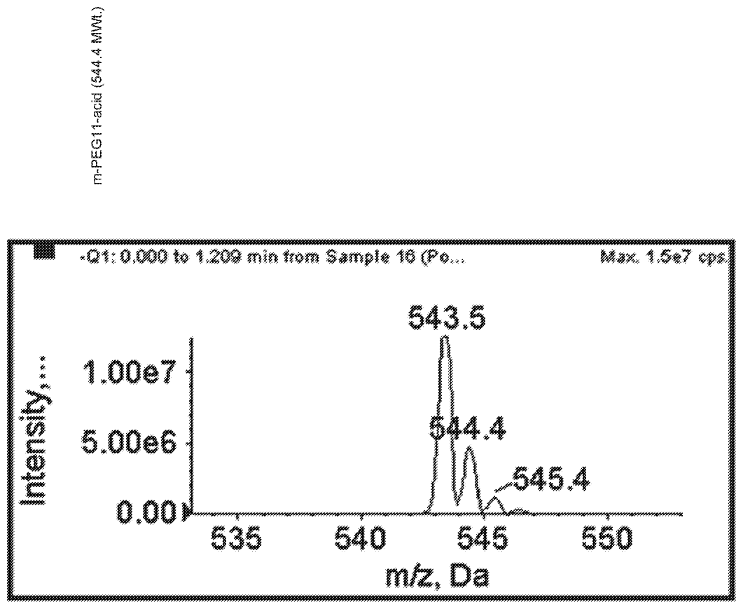

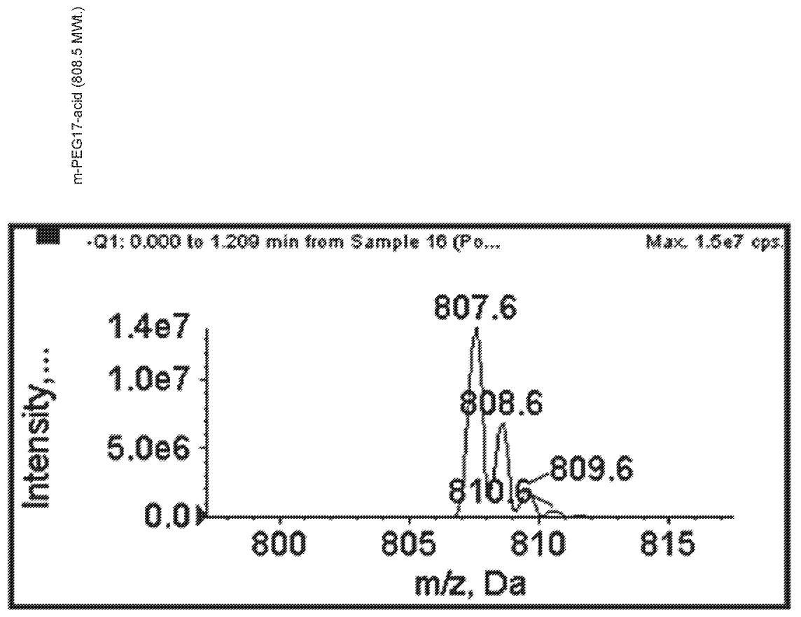

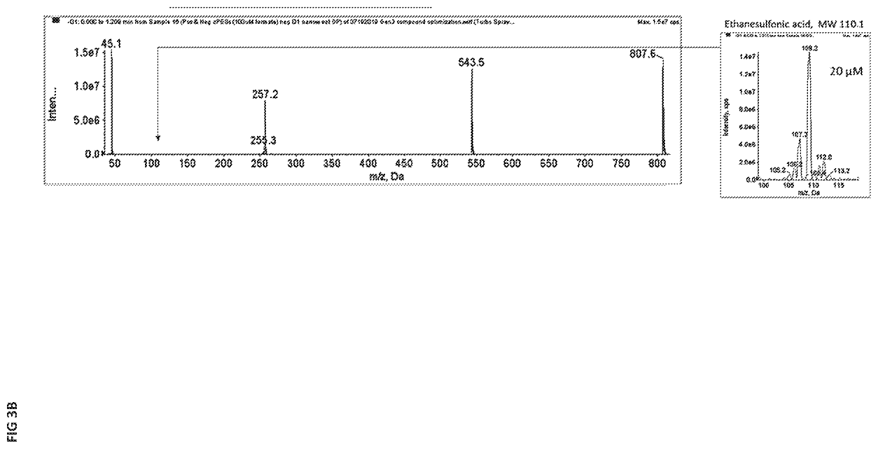

On a triple quadrupole mass spectrometer (5500 QTRAP) operating in negative ionization mode, a calibration composition comprising a mixture of dPEGs active under positive and negative mode ionization were solubilized in solvent (100 μM formate). The dPEGs ionizable under positive mode acquisition were included at a concentration of 1 μM, while the concentration of the dPEGs ionizable under negative mode acquisition were at 4 μM. The resulting spectra are depicted in FIGS. 3A-3B. The spectrum for each of the dPEGs that are ionized in negative mode, ammonium formate (45.1 MWt), hydroxyl-PEG3-sulfonic acid (258 MWt), methyl-PEG11-carboxylic acid (544.4 MWt), and methyl-PEG-17-carboxylic acid (808.5 MWt) are observable and correlate to the predicted molecular weight. No masses for any of the calibrant dPEGs that are ionizable under positive mode are observable.

### Example 1B. Calibrant Composition in Positive Mode Acquisition

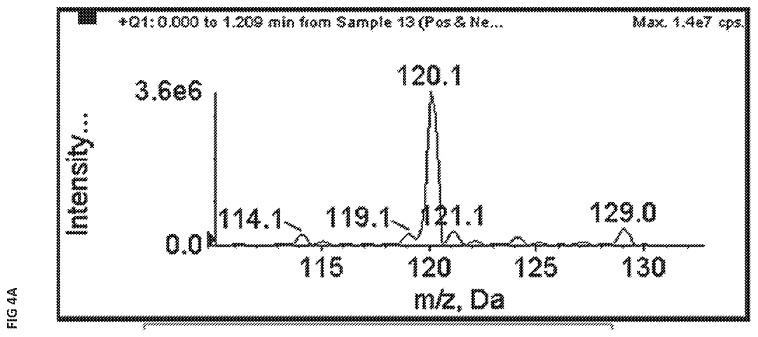

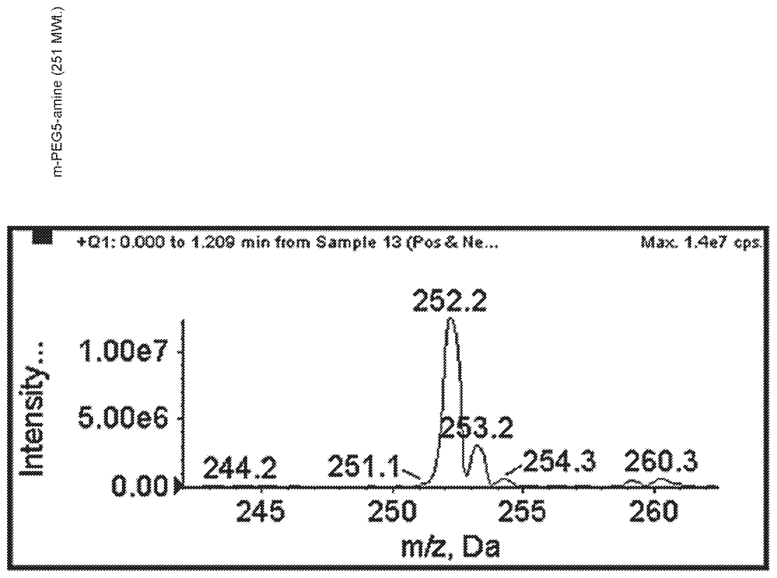

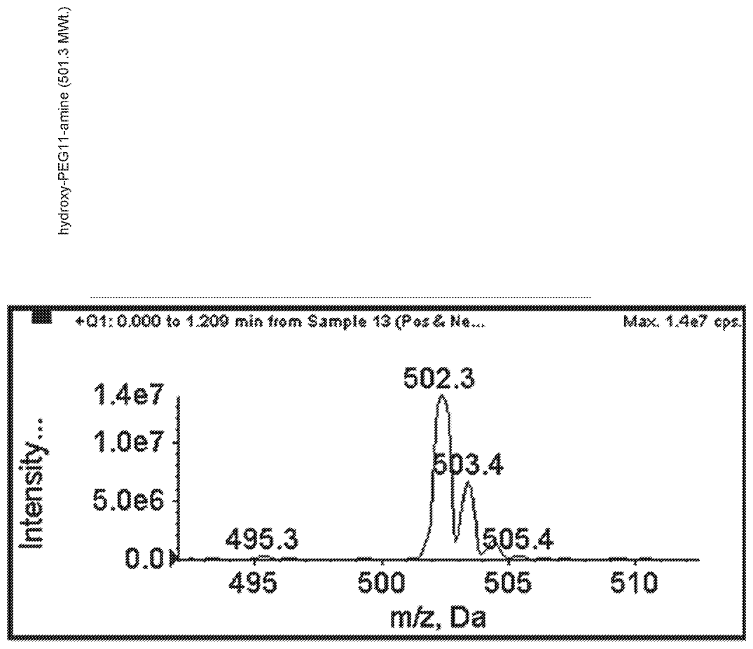

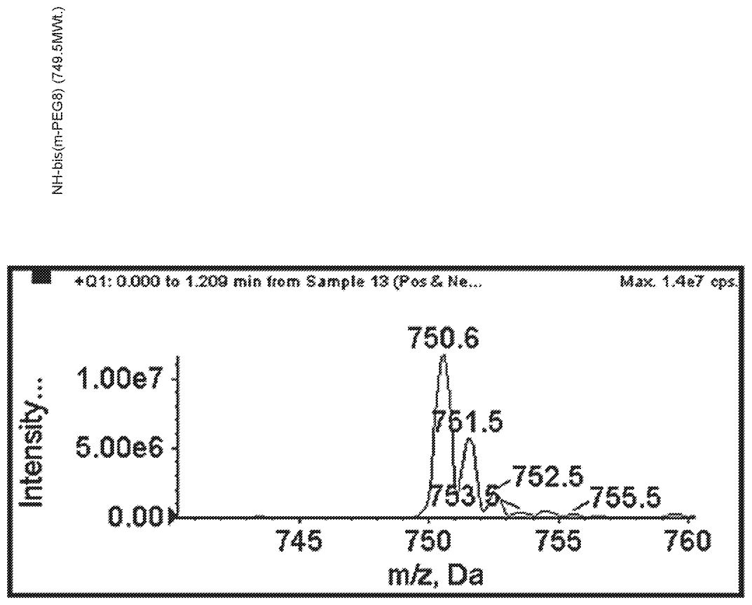

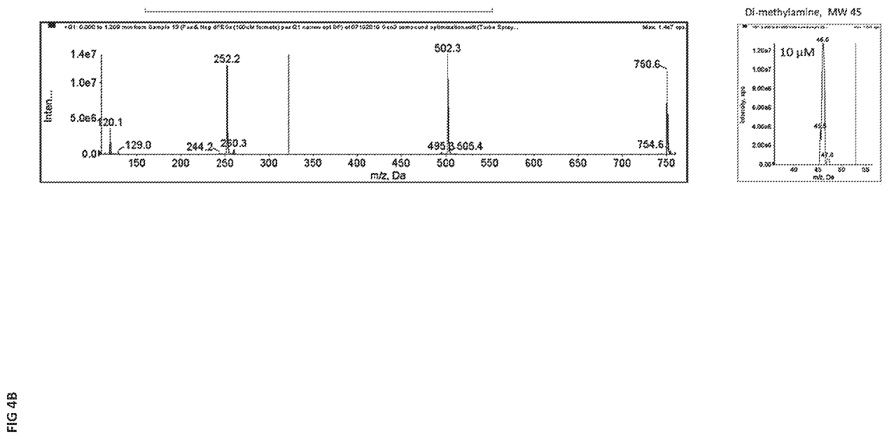

On the same triple quadrupole mass spectrometer (5500 QTRAP) the same calibration composition as used in Example 1A was used to acquire MS operating in positive ionization mode solubilized in solvent (100 μM formate). The resulting spectra are depicted in FIGS. 4A-4B. The spectrum for each of the dPEGs that are ionized in positive mode, dimethyl amine (45.0 MWt), methyl-PEG2-amine (119 MWt), methyl-PEG5-amine (251 MWt), hydroxy-PEG-11-amine (501.3 MWt), and bis-methyl-PEG8-amine (749.5 MWt) are observable and correlate to the predicted molecular weight. No masses for any of the calibrant dPEGs that are ionizable under negative mode are observable.

While the above disclosure and appended Figures provides description of various aspects and embodiments it is merely illustrative of the technology, and should not serve to limit the scope of spirit of the appended claims. Various alternatives, variations, modifications, and equivalents will be apparent to those skilled in the art.

1. (canceled)

2. (canceled)

3. A composition comprising a plurality of discrete polyethylene glycol compounds (dPEGs), wherein the plurality of dPEGs comprises a functional group that is ionizable under only one of positive mode ionization or negative mode ionization, wherein the plurality of dPEGs comprise one or more (I) dPEG-amine derivatives, (II) dPEG-carboxylic acid derivatives, (III) dPEG-sulfonic acid derivatives, and/or (IV) dPEG-phenolic derivatives.

4. The composition according to claim 3, wherein the plurality of dPEGs are selected from the Formulas: 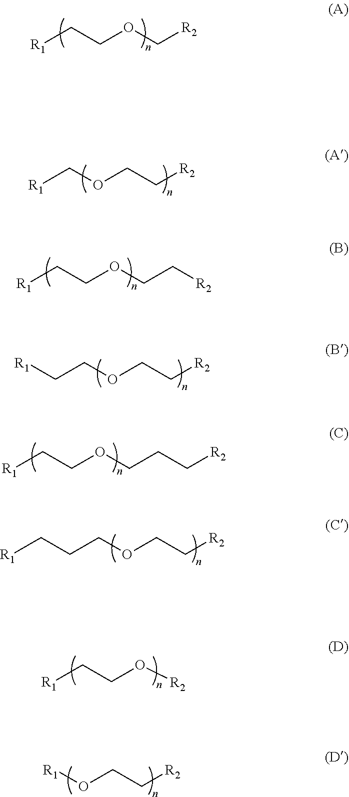
wherein R₂ is selected from an amine group, a carboxylic acid group, a sulfonic acid group, and a phenolic group; and wherein R₁ is selected from —H, —CH₃, —OH, —CH₂OH, —(CH₂)₂OH, —(CH₂)CCH, —CH₂N₃, —(CH₂)₂N₃, —NH₂, —CH₂NH₂, —(CH₂)₂NH₂, —CH₂SO₃H, and —(CH₂)₂SO₃H;
wherein when R₂ is an amine, R₁ is selected from —H, —CH₃, —CH₂OH, —(CH₂)₂OH, —(CH₂)CCH, —NH₂, —CH₂NH₂, and —(CH₂)₂NH₂;
wherein when R₂ is a carboxylic acid, a sulfonic acid, or a phenolic group, R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and
wherein n is from 1-50.

5. The composition according to claim 4, wherein R₂ comprises one of the following structures: 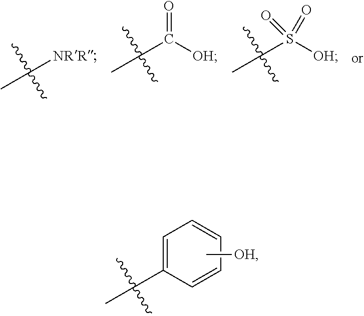
wherein R′ and R″ are independently selected from —H, and C₁-C₄ alkyl.

6. The composition according to claim 4, wherein R₁, R₂, R′, R″, and n are defined as above, but with the proviso that when R₁ is bound to oxygen it is not selected from —OH or —NH₂.

7. The composition according to claim 4, wherein R₁, R₂, R′, R″, and n are defined as above, but with the proviso that when R₂ is bound to oxygen it is not amine or sulfonic acid.

8. The composition according to claim 4, wherein n is selected from 4-25.

9. The composition according to claim 3, wherein the plurality of dPEGs comprise one or more PEG-amine derivatives selected from the following structures: 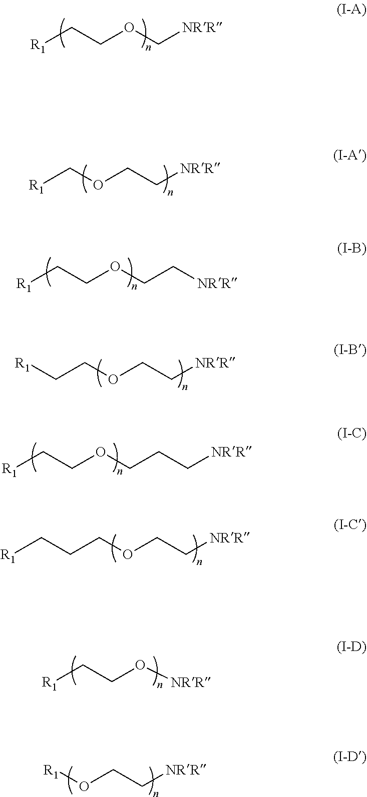
wherein R′ and R″ are independently selected from —H, and C₁-C₄ alkyl; wherein R₁ is selected from —H, —CH₃, —CH₂OH, —(CH₂)₂OH, —(CH₂)CCH, —NH₂, —CH₂NH₂, and —(CH₂)₂NH₂; and
wherein n is from 1-50.

10. The composition according to claim 9, wherein one or both of R′and R″ are H.

11. The composition according to claim 3, wherein the plurality of dPEGs comprise one or more dPEG-carboxylic acid derivatives selected from the following structures: 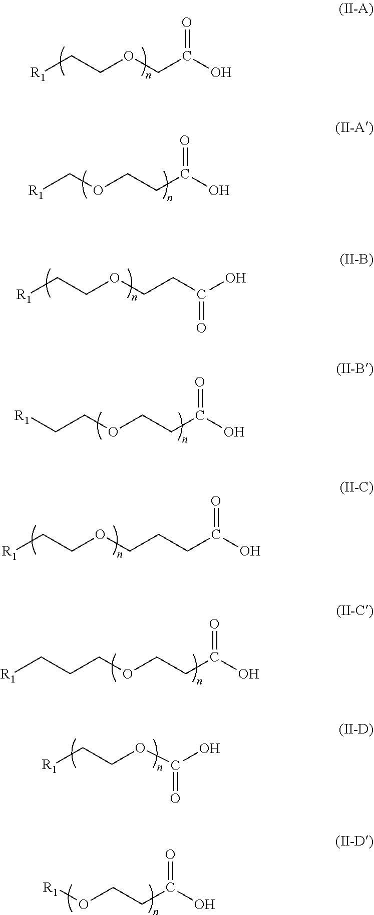
wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

12. The composition according to claim 3, wherein the plurality of dPEGs comprise one or more dPEG-sulfonic acid derivatives selected from the following structures: 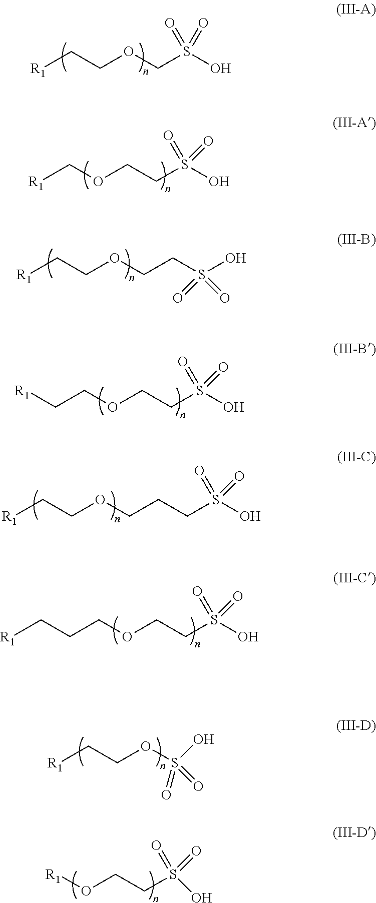
wherein R₁ is selected from —H, —CH₃, —OH, —CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

13. The composition according to claim 3, wherein the plurality of dPEGs comprise one or more dPEG-phenolic derivatives selected from the following structures: 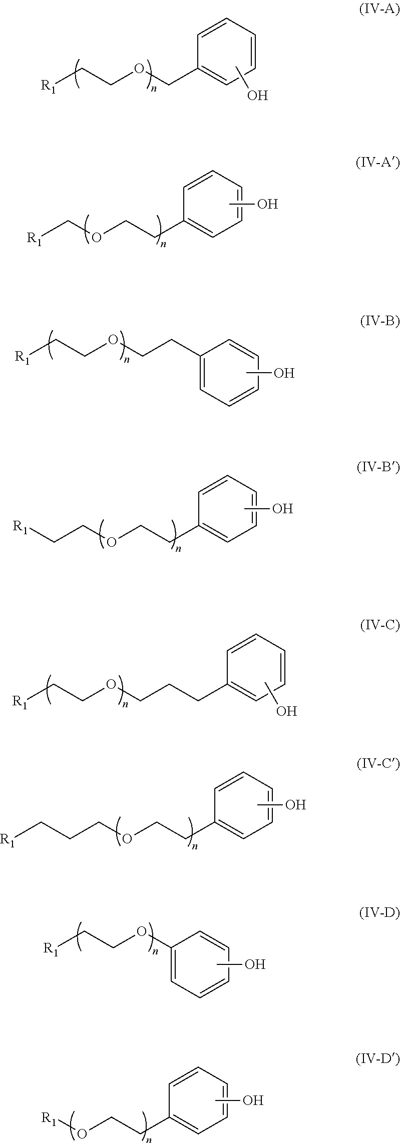
wherein R₁ is selected from —H, —CH₃, —OH, CH₂OH, —(CH₂)₂OH, —(CH₂)CCH, —CH₂N₃, —(CH₂)₂N₃, —CH₂SO₃H, and —(CH₂)₂SO₃H; and wherein n is from 1-50.

14. The composition according to claim 3, wherein the composition comprises a plurality of dPEG derivatives selected from:
(i) a plurality of dPEG-amine derivatives according to Formulas (I-A, I-A′, I-B, I-B′, I-C, I-C′, I-D, and I-D′) and a plurality of dPEG-carboxylic acid derivatives according to Formulas (II-A, II-A′, II-B, II-B′, II-C, II-C′, II-D, and II-D′);
(ii) a plurality of dPEG-amine derivatives according to Formulas (I-A, I-A′, I-B, I-B′, I-C, I-C′, I-D, and I-D′) and a plurality of dPEG-sulfonic acid derivatives according to Formulas (III-A, III-A′, III-B, III-B′, III-C, III-C′, III-D, and III-D′);
(iii) a plurality of dPEG-amine derivatives according to Formulas (I-A, I-A′, I-B, I-B′, I-C, I-C′, I-D, and I-D′) and a plurality of dPEG-phenolic acid derivatives according to Formulas (IV-A, IV-A′, IV-B, IV-B′, IV-C, IV-C′, IV-D, and IV-D′);
(iv) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), and at least one dPEG-sulfonic acid derivative according to Formulas (III-A, III-A′, III-B, III-B′, III-C, III-C′, III-D, and III-D′);
(v) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), and at least one dPEG-phenolic acid derivative according to Formulas (IV-A, IV-A′, IV-B, IV-B′, IV-C, IV-C′, IV-D, and IV-D′);
(vi) a plurality of dPEG-amine derivatives according to Formulas (I-A, I-A′, I-B, I-B′, I-C, I-C′, I-D, and I-D′), at least one dPEG-sulfonic acid derivative according to Formulas (III-A, III-A′, III-B, III-B′, III-C, III-C′, III-D, and III-D′), and at least one dPEG-carboxylic acid derivative according to Formulas (II-A, II-A′, II-B, II-B′, II-C, II-C′, II-D, and II-D′);
(vii) a plurality of dPEG-amine derivatives according to Formulas (I-A, I-A′, I-B, I-B′, I-C, I-C′, I-D, and I-D′), at least one dPEG-sulfonic acid derivative according to Formulas (III-A, III-A′, III-B, III-B′, III-C, III-C′, III-D, and III-D′), and at least one dPEG-phenolic acid derivative according to Formulas (IV-A, IV-A′, IV-B, IV-B′, IV-C, IV-C′, IV-D, and IV-D′);
(viii) a plurality of dPEG-amine derivatives according to Formulas (I-A, I-A′, I-B, I-B′, I-C, I-C′, I-D, and I-D′), at least one dPEG-phenolic acid derivative according to Formulas (IV-A, IV-A′, IV-B, IV-B′, IV-C, IV-C′, IV-D, and IV-D′), and at least one dPEG-carboxylic acid derivative according to Formulas (II-A, II-A′, II-B, II-B′, II-C, II-C′, II-D, and II-D′);
(ix) a plurality of dPEG-amine derivatives according to Formulas (I-A, I-A′, I-B, I-B′, I-C, I-C′, I-D, and I-D′), at least one dPEG-phenolic acid derivative according to Formulas (IV-A, IV-A′, IV-B, IV-B′, IV-C, IV-C′, IV-D, and IV-D′), and at least one dPEG-sulfonic acid derivative according to Formulas (III-A, III-A′, III-B, III-B′, III-C, III-C′, III-D, and III-D′); and
(x) a plurality of dPEG-amine derivatives according to Formulas (I-A, I-A′, I-B, I-B′, I-C, I-C′, I-D, and I-D′), at least one dPEG-carboxylic acid derivative according to Formulas (II-A, II-A′, II-B, II-B′, II-C, II-C′, II-D, and II-D′), at least one dPEG-sulfonic acid derivative according to Formulas (III-A, III-A′, III-B, III-B′, III-C, III-C′, III-D, and III-D′), and at least one dPEG-phenolic acid derivative according to Formulas (IV-A, IV-A′, IV-B, IV-B′, IV-C, IV-C′, IV-D, and IV-D′).

15. (canceled)

16. A method for calibrating a mass spectrometer comprising:
a) obtaining a mass spectrum of a composition comprising a plurality of discrete polyethylene glycol compounds (dPEGs), wherein the plurality of dPEGs comprises a functional group that is ionizable under only one of positive mode ionization or negative mode ionization, wherein the plurality of dPEGs comprise one or more (I) dPEG-amine derivatives, (II) dPEG-carboxylic acid derivatives, (III) dPEG-sulfonic acid derivatives, and/or (IV) dPEG-phenolic derivatives;
b) determining the differences between the expected mass peaks for the plurality of dPEG derivatives in the composition, and the corresponding actual mass peaks in the mass spectrum; and
c) adjusting the mass spectrometer based on the differences between the expected mass peaks and the actual mass peaks.

17. The method according to claim 16, wherein the method calibrates the mass spectrometer in positive ionization mode or negative ionization mode.

18. The method according to claim 16, wherein the calibrating further comprises
determining the differences between an expected intensity for one or more of the plurality of dPEG derivatives in the composition, and the corresponding actual intensity of the one or more of the plurality of dPEG derivatives in the mass spectrum,
wherein the expected intensity is determined from a known concentration of the one or more of the plurality of dPEG derivatives, and
adjusting the mass spectrometer based on the differences between the expected intensity and the actual intensity in the mass spectrum.

19. The method according to claim 16, wherein the mass spectrometer is an ESI spectrometer, an APCI mass spectrometer, or a MALDI mass spectrometer.

20. The method of claim 19, wherein the mass spectrometer is an APCI or and ESI.

21. The method according to claim 16, wherein the method is performed in MS/MS mode.

22. The method according to claim 16, wherein the method calibrates the mass spectrometer across a weight range of approximately 100 to 2500 Da.
